(19) United States
(12) Patent Application Publication
(10) Pub. No.: US 2015/0148493 A1
(43) Pub. Date: May 28, 2015

(54) CURABLE FLUOROELASTOMER COMPOSITION

(71) Applicant: E I DU PONT DE NEMOURS AND COMPANY, Wilmington, DE (US)

(72) Inventor: Ming-Hong Hung, WILMINGTON, DE (US)

(21) Appl. No.: 14/548,416

(22) Filed: Nov. 20, 2014

Related U.S. Application Data
(60) Provisional application No. 61/908,293, filed on Nov. 25, 2013.

(51) Int. Cl. C08F 216/14

(52) U.S. Cl. CPC C08F 216/1408
USPC 525/326.3

(57) ABSTRACT

Compositions comprising fluoroelastomers having copolymerized units of a cyano-containing cure site monomer are cured (i.e. crosslinked) with certain aromatic diazide curatives. The crosslinks are tetrazole rings formed by the reaction of the aromatic diazide with pendant cyano groups on the fluoroelastomer.

### CROSS REFERENCE TO RELATED APPLICATIONS

This application claims the benefit of U.S. Provisional Application No. 61/908,293, filed Nov. 25, 2013, now pending, the entire disclosure of which is incorporated herein by reference.

### FIELD OF THE INVENTION

This invention relates to curable fluoroelastomer compositions wherein the fluoroelastomer has cyano group cure sites and the curative is an aromatic diazide.

### BACKGROUND OF THE INVENTION

Fluoroelastomers have achieved outstanding commercial success and are used in a wide variety of applications in which severe environments are encountered, in particular those end uses where exposure to high temperatures and aggressive chemicals occurs. For example, these polymers are often used in seals for aircraft engines, in oil-well drilling devices, and in sealing elements for industrial equipment that operates at high temperatures.

The outstanding properties of fluoroelastomers are largely attributable to the stability and inertness of the copolymerized fluorinated monomer units that make up the major portion of the polymer backbones in these compositions. Such monomers include vinylidene fluoride, hexafluoropropylene, tetrafluoroethylene and perfluoro(alkyl vinyl) ethers. In order to develop elastomeric properties fully, fluoroelastomers are typically crosslinked, i.e. vulcanized. To this end, a small percentage of cure site monomer is copolymerized with the fluorinated monomer units. Cure site monomers containing at least one cyano group, for example perfluoro-8-cyano-5-methyl-3,6-dioxa-1-octene, are especially preferred. Such compositions are described in U.S. Pat. Nos. 4,281,092; 4,394,489; 5,789,489; 5,789,509 and in WO 2011084404.

U.S. Pat. No. 8,288,005 B2 discloses perfluoroelastomers having cyano cure sites that are cured with certain aliphatic mono-, di- and poly-azides. However, these azides may be difficult to synthesize and can be challenging to purify via distillation. The azides tend to have poor stability (both thermal and explosive). Also the azides are usually liquids at room temperature which can make it difficult to compound with fluoroelastomers.

U.S. Pat. No. 8,288,482 B2 discloses perfluoroelastomers having cyano cure sites that are cured with certain diazides. These diazides may suffer from many of the deficiencies mentioned above.

Aromatic diazides are very easy to prepare (usually they are solids) and can be purified by recrystallization. Aromatic diazides generally have good chemical stability, so they are relatively easy to handle.

### SUMMARY OF THE INVENTION

Surprisingly, it has been discovered that aromatic diazides may be employed as curatives for fluoroelastomers having pendant cyano groups even though the aromatic group provides steric hindrance to the crosslinking reaction. The curable compositions exhibit good curing characteristics (e.g. cure rate and cure level) and result in cured fluoroelastomer compositions having good physical properties.

The present invention is directed to a curable fluoroelastomer composition which comprises a fluoroelastomer having cyano group cure sites and a certain aromatic diazide. More specifically, the present invention is directed to a curable composition comprising:
A) a fluoroelastomer comprising copolymerized units of a cyano group-containing cure site monomer; and
B) at least one aromatic diazide curative having the formula N₃—R—N₃, wherein R is an aromatic moiety selected from the group consisting of C₆H₄, (C₆H₄)₂, C₁₀H₆ and C₆H₄—X—C₆H₄, and wherein X is selected from the group consisting of C(CF₃)₂, O, SO, SO₂, CO and C(CH₃)₂.

Another aspect of the present invention is a cured article made from the above composition.

### DETAILED DESCRIPTION OF THE INVENTION

The fluoroelastomer that may be employed in the composition of the invention may be partially fluorinated or perfluorinated. Fluoroelastomers preferably contain between 25 and 70 weight percent, based on the total weight of the fluoroelastomer, of copolymerized units of a first monomer which may be vinylidene fluoride (VF₂) or tetrafluoroethylene (TFE). The remaining units in the fluoroelastomers are comprised of one or more additional copolymerized monomers, different from said first monomer, selected from the group consisting of fluoromonomers, hydrocarbon olefins and mixtures thereof. Fluoromonomers include fluorine-containing olefins and fluorine-containing vinyl ethers.

Fluorine-containing olefins which may be employed to make fluoroelastomers include, but are not limited to vinylidene fluoride (VF₂), hexafluoropropylene (HFP), tetrafluoroethylene (TFE), 1,2,3,3,3-pentafluoropropene (1-HPFP), 1,1,3,3,3-pentafluoropropene (2-HPFP), chlorotrifluoroethylene (CTFE) and vinyl fluoride.

Fluorine-containing vinyl ethers that may be employed to make fluoroelastomers include, but are not limited to perfluoro(alkyl vinyl) ethers. Perfluoro(alkyl vinyl) ethers (PAVE) suitable for use as monomers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl ether) (PMVE), perfluoro(ethyl vinyl ether) (PEVE) and perfluoro(propyl vinyl ether) (PPVE). Other useful monomers include those of the formula

CF₂═CFO[(CF₂)ₘCF₂CFZO]ₙR_{f} (III)

where R_{f} is a perfluoroalkyl group having 1-6 carbon atoms,
m=0 or 1, n=0-5, and Z═F or CF₃. Preferred members of this class are those in which R_{f} is C₃F₇, m=0, and n=1.

Additional perfluoro(alkyl vinyl) ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers employed in the invention, the PAVE content generally ranges from 25 to 75 weight percent, based on the total weight of the fluoroelastomer. If perfluoro(methyl vinyl ether) is used, then the fluoroelastomer preferably contains between 30 and 65 wt. % copolymerized PMVE units.

Hydrocarbon olefins useful in the fluoroelastomers employed in the invention include, but are not limited to ethylene and propylene. If copolymerized units of a hydrocarbon olefin are present in the fluoroelastomers, hydrocarbon olefin content is generally 4 to 30 weight percent.

The fluoroelastomer further contains copolymerized units of at least one cure site monomer, generally in amounts of from 0.1-5 mole percent. The range is preferably between 0.3-1.5 mole percent. Although more than one type of cure site monomer may be present, most commonly one cure site monomer is used and it contains at least one cyano substituent group. Suitable cure site monomers include cyano-containing fluorinated olefins and cyano-containing fluorinated vinyl ethers. Useful cyano-containing cure site monomers include those of the formulas shown below.

CF₂═CF—O(CF₂)ₙ—CN (VI)

where n=2-12, preferably 2-6;

CF₂═CF—O[CF₂—CFCF₃—O]ₙ—CF₂—CFCF₃—CN (VII)

where n=0-4, preferably 0-2;

CF₂═CF—[OCF₂CFCF₃]ₓ—O—(CF₂)ₙ—CN (VIII)

where x=1-2, and n=1-4; and

CF₂═CF—O—(CF₂)ₙ—O—CF(CF₃)CN (IX)

where n=2-4.
Those of formula (VIII) are preferred. Especially preferred cure site monomers are perfluorinated polyethers having a cyano group and a trifluorovinyl ether group. A most preferred cure site monomer is

CF₂═CFOCF₂CF(CF₃)OCF₂CF₂CN (X)

i.e. perfluoro(8-cyano-5-methyl-3,6-dioxa-1-octene) or 8-CNVE.

Fluoroelastomers that may be employed in the invention have a number average molecular weight (Mn) in the range of 10,000 to 250,000 daltons.

A first aspect of this invention is a curable composition comprising A) a fluoroelastomer comprising copolymerized units of a cyano group-containing cure site monomer; and B) a certain aromatic diazide. The aromatic diazide has the formula N₃—R—N₃, wherein R is an aromatic moiety selected from the group consisting of C₆H₄, (C₆H₄)₂, C₁₀H₆ and C₆H₄—X—C₆H₄, and wherein X is selected from the group consisting of C(CF₃)₂, O, SO, SO₂, CO and C(CH₃)₂. Optionally, these aromatic azides may contain substituents on the aromatic ring which do not interfere with the crosslinking reaction. Such optional substituents include, but are not limited to CH₃, OCH₃, NO₂, SH, OH, etc.

Specific aromatic diazides that may be employed in this invention include, but are not limited to

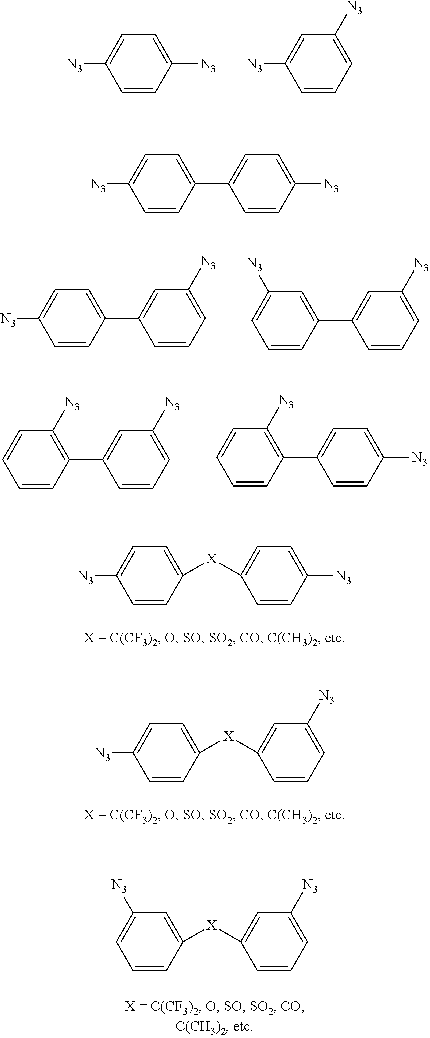

Also above structures with additional substituents on the aromatic rings that will not interfere with the crosslinking chemistry, such as Me, R, OMe, OR, NO₂, Ar, SR, OH, etc.

These aromatic diazides crosslink the fluoroelastomer copolymer by reacting with pendant cyano groups on the fluoroelastomer polymer chains to form tetrazole rings. The resulting crosslinks are stable to high temperatures.

Aromatic diazides offer several advantages over aliphatic diazides as the curative for fluoroelastomers. Aromatic diazides are more chemically stable and safer to handle than aliphatic diazides. The aromatic diazides form aromatic tetrazole crosslinks which are more thermally stable than aliphatic tetrazole crosslinks. Also, aromatic diazides are easier and safer to purify (e.g. recrystallization) than aliphatic diazides (e.g. distillation). However, in general aromatic diazides are more sterically hindered than aliphatic azides. Thus it is surprising that aromatic diazides provide desirable cure rates and result in cured fluoroelastomer articles having good physical properties.

In order to be useful as a curative for these fluoroelastomers, the level of aromatic diazide should be about 0.1 to 7 parts per 100 parts fluoroelastomer, preferably about 1 to 5 parts aromatic diazide per 100 parts fluoroelastomer. As used herein, “parts” refers to parts by weight, unless otherwise indicated.

Optionally, the curable compositions of the invention may further comprise 0.1 to 3 parts of a metal halide, e.g. ZnCl₂ or CuBr, per 100 parts fluoroelastomer. The metal halide catalyzes the crosslinking reaction to form tetrazole rings.

Additives, such as carbon black, fluoropolymer micropowders, stabilizers, plasticizers, lubricants, fillers, and processing aids typically utilized in fluoroelastomer compounding can be incorporated into the compositions of the present invention, provided they have adequate stability for the intended service conditions.

The curable compositions of the invention may be prepared by mixing the fluoroelastomer, aromatic diazide and other components using standard rubber compounding procedures. For example, the components may be mixed on a two roll rubber mill, in an internal mixer (e.g. a Banbury® internal mixer), or in an extruder. The curable compositions may then be crosslinked (i.e. cured) by application of heat and/or pressure. When compression molding is utilized, a press cure cycle is generally followed by a post cure cycle during which the press cured composition is heated at elevated temperatures in excess of 200° C. for several hours.

The curable compositions of the present invention are useful in production of gaskets, tubing, and seals. Such cured articles are generally produced by molding a compounded formulation of the curable composition with various additives under pressure, curing the part, and then subjecting it to a post cure cycle.

Other fluoropolymers containing cyano cure sites, such as fluoroplastics may be substituted for fluoroelastomers in the compositions of the invention.

Also the curable compositions of the invention may contain more than one type of aromatic diazide curative and may also contain (in addition to the aromatic diazide) more than one type of curative commonly employed in the crosslinking of fluoroelastomers, e.g. organic peroxide, diamino bisphenol AF, urea, organotin compounds such as tetraphenyltin, etc.

The invention is now illustrated by certain embodiments wherein all parts are by weight unless otherwise specified.

### EXAMPLES

### Test Methods

Cure Characteristics

Cure characteristics were measured using a Monsanto MDR 2000 instrument under the following conditions:
Moving die frequency: 1.66 Hz
Oscillation amplitude: ±0.5 degrees
Temperature: 199° C., unless otherwise noted
Sample size: Disks having diameter of 1.5 inches (38 mm)
Duration of test: 30 minutes

The following cure parameters were recorded:
M_{H}: maximum torque level, in units of dN·m
M_{L}: minimum torque level, in units of dN·m
Tc90: time to 90% of maximum torque, minutes

Test specimens were prepared from elastomer compounded with appropriate additives, as described in the formulations listed in the Examples below. Compounding was carried out on a rubber mill. The milled composition was formed into a sheet and a 10 g sample was die cut into a disk to form the test specimen.

Compression set of O-ring samples was determined in accordance with ASTM D395-89, 25% deflection for 70 hours at 200° C. Mean values are reported.

The following fluoroelastomer polymer was used in the Examples:

A terpolymer containing 61.8 mole percent units of TFE, 37.4 mole percent units of PMVE and 0.8 mole percent units of 8-CNVE was prepared according to the general process described in U.S. Pat. No. 5,789,489.

The following aromatic diazides were employed as curatives in the Examples: Curative 1. Preparation of 4,4′-(Hexafluoroisopropylidene)-Bis(azidobenzene):

In a reaction flask was charged water (30 mL) and concentrated sulfuric acid (12 mL). The 4,4′-(hexafluoroisporopylidene)-dianiline (10 g, 0.03 moles) substrate was added with vigorous stirring. After the addition, the reaction mixture was stirred at ambient temperature for 2 hours, and all the amine was converted to the white sulfate salt. More water (16 mL) was added and the mixture was cooled to 10-15° C. A solution of sodium nitrite (4.42 g, 0.064 moles) in water (12 mL) was then added slowly. After addition, the mixture was stirred another 1.5 hours at ambient temperature, then sodium azide (4.8 g, 0.074 moles) in water (16 mL) was added dropwise, with vigorous stirring. Foam formation was observed. The mixture was stirred for 2 hours at ambient temperature. The thick white solid was then filtered and washed with water thoroughly. After pressing free of excess water, the material was allowed to dry in air under “dark” conditions (e.g. covered with aluminum foil), thus affording the desired di-azide product as a white powder (12.5 g, ˜ quantitative yield), Melting point: 85-88° C. ¹H-NMR (400 MHz, CDCl₃): δ 7.36 (d, J=8.6 Hz, 4H), 7.03 (m, 4H); ¹⁹F-NMR (376.86 MHz, CDCl₃): −64.6 (s); IR (KBr): 2137 cm⁻¹; 2100 cm⁻¹.

Curative 2. Preparation of 3,3′-Diazido-4,4′-(hexafluoroisporopylidene)-Bisphenol:

In a reaction flask was charged water (40 mL) and concentrated sulfuric acid (16 mL). The 3,3′-diamino-4,4′-(hexafluoroisporopylidene)-bisphenol (14.6 g, 0.04 moles) substrate was added with vigorous stirring. After the addition, the reaction mixture was stirred at ambient temperature for 2 hours, and all the amine was converted to the sulfate salt. Additional water (20 mL) was added and the mixture was cooled to 10-15° C. A solution of sodium nitrite (5.9 g, 0.085 moles) in water (20 mL) was then added slowly. After addition, the mixture was stirred another 1.5 hours at ambient temperature, then sodium azide (6.4 g, 0.099 moles) in water (20 mL) was added dropwise, with vigorous stirring. Foam formation was observed. The mixture was stirred for 2 hours at ambient temperature. The resulting yellow solid was collected by filtration and washed with water thoroughly. After pressing free of excess water, the material was allowed to dry in air under “dark” conditions (e.g. covered with aluminum foil), thus affording the desired di-azide product as a yellow powder (14 g, 88.5% yield), ¹H-NMR (400 MHz, acetone-d₆): δ 6.55-7.88 (m, 6H); ¹⁹F-NMR (376.86 MHz, acetone-d₆): −63.8 (s); IR (KBr): 2173 cm⁻¹; 2120 cm⁻¹.

### Curative 3. Preparation of 4,4′-Diazido-Bisphenyl Ether:

In a reaction flask was charged water (20 mL) and concentrated sulfuric acid (10 mL). The oxydianiline (5 g, 0.25 moles) substrate was added slowly with vigorous stirring. After the addition, the reaction mixture was stirred at ambient temperature for 2 hours and all the amine was converted to the white sulfate salt. Additional water (13 mL) was added and the mixture was cooled to 10-15° C. A solution of sodium nitrite (3.73 g, 0.054 moles) in water (16 mL) was then added slowly. After addition, the mixture was stirred another 1.5 hours at ambient temperature, then sodium azide (4.0 g, 0.062 moles) in water (13 mL) was added dropwise, with vigorous stirring while the reaction flask was kept cold with external ice water cooling. Foam formation was observed. The mixture was stirred for 2 hours at ambient temperature. The resulting grey solid was filtered and washed with water thoroughly. After pressing free of excess water, the material was allowed to dry in air under “dark” conditions (e.g. covered with aluminum foil), thus affording the desired diazide product as a powder (7 g, ˜ quantitative yield), melting point: 71-73° C. ¹H-NMR (400 MHz, THF-d₈): δ 7.09 (m); IR (KBr): 2256 cm⁻¹; 2117 cm⁻¹.

### Examples 1-4

Curable compositions of the invention were compounded on a two-roll rubber mill in the proportions shown in Table I. Cure characteristics of the compounded compositions are also shown in Table I.

TABLE I

| | Ex. 1 | Ex. 2 | Ex. 3 | Ex. 4 |
|---|---|---|---|---|
| Formulation | | | | |
| (phr)¹ | | | | |
| Fluoroelastomer | 100 | 100 | 100 | 100 |
| Carbon Black MT | 30 | 30 | 30 | 30 |
| N990 | | | | |
| Curative 1 | 2.25 | 2.25 | 2.25 | 2.25 |
| ZnCl₂ | 0 | 1.0 | 0 | 1.0 |
| CuBr | 0 | 0 | 1.0 | 0 |
| Cure | | | | |
| Characteristics | | | | |
| M_{L} (dN · m) | 2.34 | 2.17 | 2.04 | 1.36 |
| M_{H} (dN · m) | 10.94 | 8.00 | 6.90 | 7.30 |
| Tc90, minutes | 8.64 | 10.09 | 6.90 | 8.53 |

¹Parts per hundred parts fluoroelastomer

### Examples 5-7

Curable compositions of the invention were compounded on a two-roll rubber mill in the proportions shown in Table II. Cure characteristics of the compounded compositions are also shown in Table II.

O-rings were made by press curing at 199° C., followed by a post cure under nitrogen at 305° C. for 42 hours. Compression set values of the o-rings are also shown in Table II.

TABLE II

| | Ex. 5 | Ex. 6 | Ex. 7 |
|---|---|---|---|
| Formulation | | | |
| (phr)¹ | | | |
| Fluoroelastomer | 100 | 100 | 100 |
| Carbon Black MT | 30 | 30 | 30 |
| N990 | | | |
| Curative 1 | 2.75 | 2.75 | 2.75 |
| CuBr | 0 | 0 | 1.0 |
| 2,2′-dipyridyl | 0 | 0 | 1.0 |
| Cure | | | |
| Characteristics | | | |
| M_{L} (dN · m) | 2.72 | 2.54 | 1.62 |
| M_{H} (dN · m) | 11.05 | 8.38 | 13.16 |
| Tc90, minutes | 9.98 | 8.72 | 8.01 |
| Compression Set | | | |
| % | 35 | 48 | 73 |

### Examples 8-10

Curable compositions of the invention were compounded on a two-roll rubber mill in the proportions shown in Table III. Cure characteristics of the compounded compositions are also shown in Table III.

O-rings were made by press curing at 199° C., followed by a post cure under nitrogen at 305° C. for 42 hours. Compression set values of the o-rings are also shown in Table III.

TABLE III

| | Ex. 8 | Ex. 9 | Ex. 10 |
|---|---|---|---|
| Formulation | | | |
| (phr)¹ | | | |
| Fluoroelastomer | 100 | 100 | 100 |
| Carbon Black MT | 30 | 30 | 30 |
| N990 | | | |
| Curative 1 | 3.2 | 3.2 | 3.2 |
| ZnCl₂ | 1.00 | 0 | 0 |
| 2,2′-dipyridyl | 0 | 1.0 | 0 |
| tetraphenyltin | 0 | 0 | 1.0 |
| Cure | | | |
| Characteristics | | | |
| M_{L} (dN · m) | 1.97 | 1.60 | 2.34 |
| M_{H} (dN · m) | 8.12 | 14.18 | 23.51 |
| Tc90, minutes | 12.79 | 9.15 | 10.36 |
| Compression Set | | | |
| % | 37 | 50 | 33 |

What is claimed is:

1. A curable composition comprising:
A) a fluoroelastomer comprising copolymerized units of a cyano group-containing cure site monomer; and
B) at least one aromatic diazide curative having the formula N₃—R—N₃, wherein R is an aromatic moiety selected from the group consisting of C₆H₄, (C₆H₄)₂, C₁₀H₆ and C₆H₄—X—C₆H₄, and wherein X is selected from the group consisting of C(CF₃)₂, O, SO, SO₂, CO and C(CH₃)₂.

2. A cured article made from the curable composition of claim 1.
